(19) United States
(12) Patent Application Publication
(10) Pub. No.: US 2006/0277267 A1
(43) Pub. Date: Dec. 7, 2006

(54) Unified memory IP packet processing platform

(76) Inventor: Simon Lok, Vero Beach, FL (US)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 11/432,055

(22) Filed: May 10, 2006

Related U.S. Application Data
(60) Provisional application No. 60/594,881, filed on May 16, 2005.

(51) Int. Cl. G06F 15/167

(52) U.S. Cl. 709/213

(57) ABSTRACT

A unified memory architecture IP packet processing platform (e.g., IPv4) that is designed to execute on a standard general purpose computer. Unlike the traditional packet processing paradigm, our platform is software pluggable and can integrate all of the functionality that is typically only available by chaining a series of discrete devices. The present invention uses a unified memory architecture that precludes the need to transfer packets between modules that implement processing functionality.

This application claims the benefit of U.S. Provisional Patent Application Ser. No. 60/594,881 filed on May 16, 2005.

### DESCRIPTION

1. Field of the Invention

The present invention relates, in general, to network data communications, and, more particularly, to software, systems and methods for providing unified memory IP packet processing in a networked computer system.

2. Relevant Background

Network data communication typically involves packet data communication. Packets or “datagrams” are formed having a data structure that complies with one or more standards that are valid for a particular network. A typical packet data structure comprises header fields that include information about the packet, a source address, a destination address, and the like. Along with the header fields is a data field or payload that carries the data being communicated by the network.

IP packets are the fundamental atom of the global infrastructure we call the Internet. Processing of IP packets occurs at many levels across a wide range of devices. The most common IP packet processing is routing, where a device receives a packet, inspects it for source and destination addresses and then makes a decision (based on administrative policy and network link status) as to where to send the packet next. The second most common form of packet processing is filtering (sometimes called firewalling) where packets are inspected and matched against rules that enforce policies regarding which kinds of traffic are permitted.

Over time, the complexity of the types of packet processing that business models require has greatly increased. In the service provider arena, the phrase “captive portal” is used to describe a packet processing methodology where World Wide Web (WWW) traffic is redirected to a predefined set of web pages that typically require the user to pay a fee to access the Internet. To accomplish this, inspection and redirection of packets is combined with a web application server.

Contemporary corporate network defense strategies often call for the deployment of intrusion protection systems (IPS). These systems employ packet processing to detect anomalous traffic and automatically block nodes that are misbehaving. In a typical enterprise network datacenter, there will be many devices connected inline that process packets in different ways. For example, packets could sequentially face a discrete router, a firewall, a bandwidth manager and an intrusion protection device. A service provider might also have a captive portal device and a web caching appliance for provisioning. A financial firm might also have content filtering, VPN and packet capture devices for regulatory compliance.

Each of these packet processors is typically implemented as a specialized single purpose appliance. Each single-purpose appliance reads the packet header and/or data fields and takes some programmed action based on the contents. These appliances must process the packet very quickly so as to avoid adding unacceptable latency in the transport of packets.

### SUMMARY OF THE INVENTION

Briefly stated, the present invention involves a unified memory architecture IP packet processing platform (IPv4) that is designed to execute on a standard general purpose computer. Unlike the traditional packet processing paradigm, the present invention provides a platform that is software pluggable and can integrate functionality that is typically only available by chaining a series of discrete devices. To accomplish this, the present invention uses a unified memory architecture that precludes the need to transfer packets between modules that implement processing functionality.

### BRIEF DESCRIPTION OF THE DRAWINGS

FIG. 1 shows an exemplary Stack of Packet Processing Devices;

FIG. 2 shows Aggregation of Packet Processors with Custom Backplane;

FIG. 3 illustrates Aggregated Packet Processor with Unified Memory Architecture;

FIG. 4 illustrates the wire format TCP/IP packets found on an Ethernet bus;

FIG. 5 illustrates an example of the data structure used in a unified buffer network provisioning system implementation;

FIG. 6 illustrates the segments of the unified buffer (601,602) and the associated meta-data table.

### DETAILED DESCRIPTION OF THE PREFERRED EMBODIMENTS

In general, the present invention involves systems and methods for providing network-edge services such as routing, firewalling, session prioritization, bandwidth management, intrusion detection, packet capture, diagnostics, content monitoring, usage tracking and billing, using parallel processing techniques. In particular implementations the parallel processing uses a shared memory hardware architecture to improve efficiency, although packet processing can be performed either in parallel, serially, or a mix of parallel and serial processing as appropriate for a particular set of edge services. The present invention also involves a shared data structure for holding all or portions of network packets that are being analyzed.

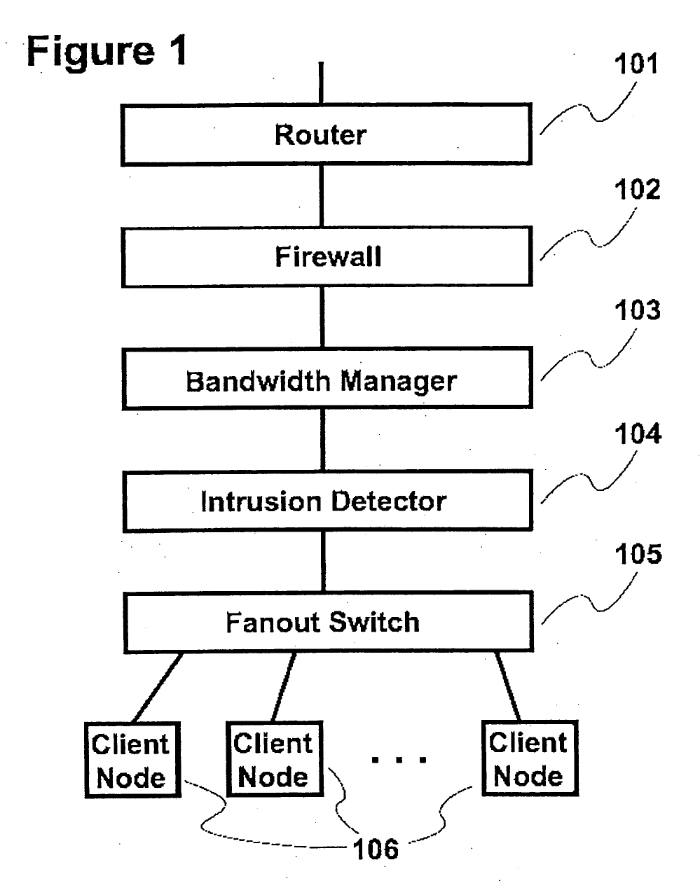

FIG. 1 shows a typical enterprise architecture that comprises a stack of packet processing devices at the network edge, including, for example, a router (101), firewall (102), bandwidth manager (103) and intrusion detector (104). A packet from the uplink (e.g., the Internet) must pass through each processing device before reaching the fanout switch (105) and finally arriving at one or more network nodes (106).

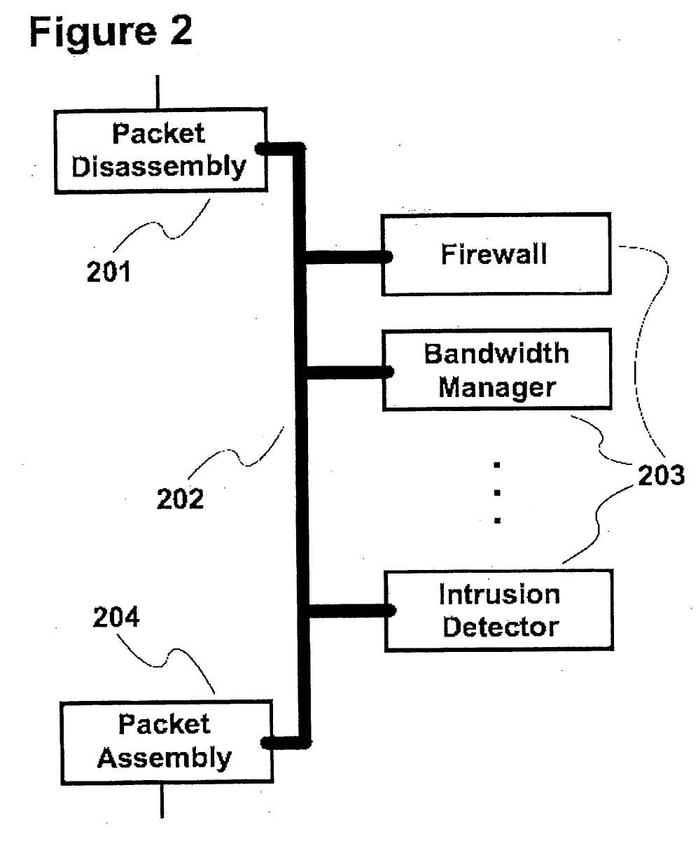

FIG. 2 shows an example of an aggregate packet processor in accordance with the present invention that takes the place of a stack of packet processing devices with a common communications backplane. Packets are translated once from their wire format to a common processable data structure (201) and vice versa (204) once, rather than multiple, serial processing steps. The common data structure may comprise, for example, the raw packet format such as an IP packet. Alternatively, the common format may comprise only a subset of fields from the raw network packet that are used by any of the processes, or may be a proprietary format that will vary from implementation to implementation. In a particular embodiment, some or all of the packet processing engines (203) may retain their own processors, memory and custom ASICs as if they were separate units. In such an implementation, the only change is the packet interface which is adapted to use the common data format from the shared memory rather than from the network interface. Packets are shared using a high performance backplane (202) in a processable format rather than transferred over a network connection in wire format.

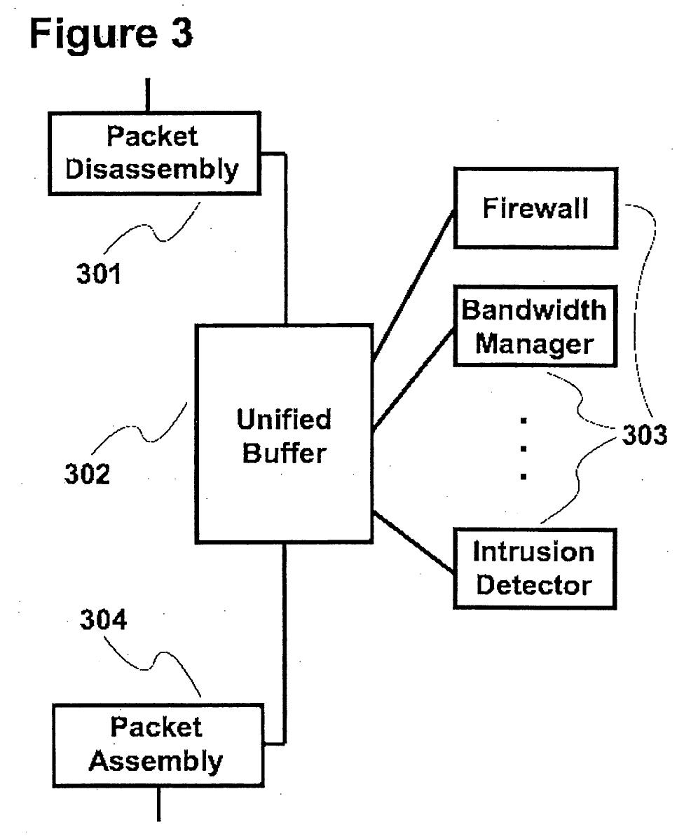

FIG. 3 illustrates an aggregated packet processor with unified memory architecture in accordance with the present invention. In order to obtain high throughput while executing an aggregated packet processing system on a general purpose computing platform, the present invention uses a unified memory architecture. Packets are translated between wire format and a processable data structure once (301,304). Packet processors (303) are implemented in software and operate in place on packets stored in a unified buffer (302).

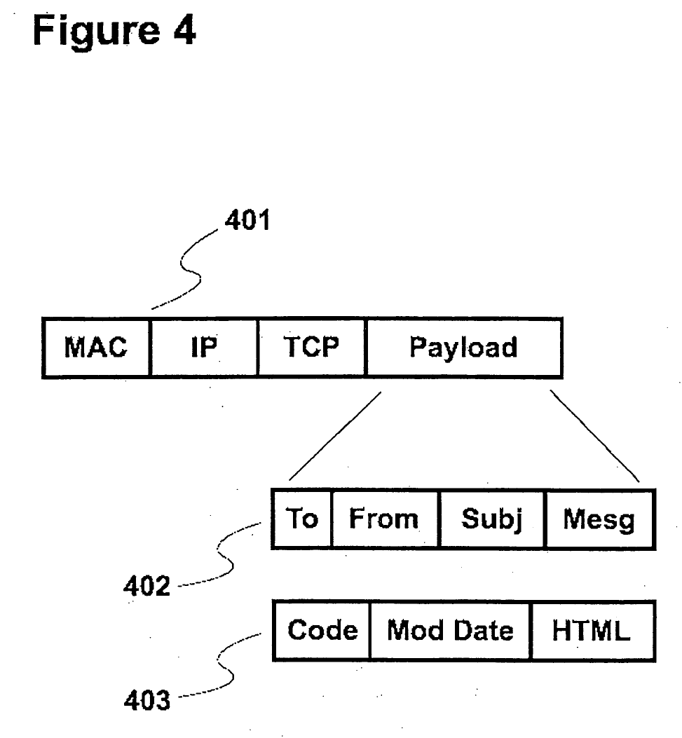

FIG. 4 illustrates the wire format TCP/IP packets found on an Ethernet bus. This would also be the most likely format used in a shared back-plane provisioning system shown in FIG. 2. A packet header (401) consisting of address and session information precedes a variable length payload. The content of the payload depends upon the application being delivered. An SMTP (email) payload (402) should contain the source and destination addresses along with a subject and the body of the email message. An HTTP (WWW page) payload must at least contain a request result code, modification date and the HTML page.

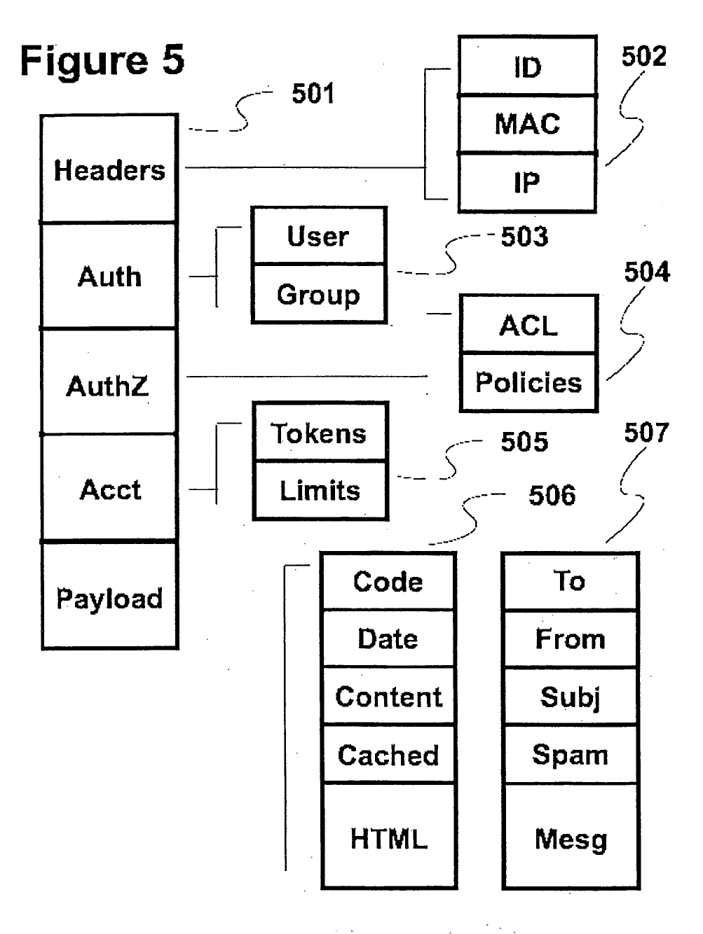

FIG. 5 illustrates an example of the 5-part data structure (501) used in a unified buffer network provisioning system implementation. The packet headers are embedded into the header section (502) of the data structure along with a unique identifier. An authentication meta-data section (503) includes meta-data such as the user and group associated with the source or destination node. An authorization meta-data section (504) includes meta-data such as access control lists and content filtering, caching, behavior, utilization and prioritization policies. An accounting meta-data section (505) includes billing and usage tracking meta-data such as the session tokens associated with the transmitting node as well as limits on the number of bytes transferred or seconds connected. Finally, the packet payload is stored along with payload-specific meta-data. For example, an HTTP payload (506) contains the packet payload along with meta-data describing the state of the transparent web cache and the classification of the content. An SMTP payload (507) contains the usual email headers and message along with the result of a spam classification engine.

FIG. 6 illustrates the segments of the unified buffer (601,602) and the associated meta-data table (603). Individual segments may have multiple packets (in shared data structure format) inside of it (601), or only one packet inside (602), depending on the size of the constituent packets. Each segment has an entry in the meta-data tracking table (603) where meta-data including but not limited to a locking bit, the active processor and the status of the packet in the provisioning pipeline. Although it is possible to include the meta-data into the segment itself, the particular implementation includes the meta-data to leverage the locality of reference when a provisioning module needs to search for an unprocessed and unlocked packet.

Traditional network architecture calls for a series of packet processing devices to be connected serially, an example of which is depicted in FIG. 1. Packets pass into a device, are processed, and are forwarded on to the next device. Packets are typically forwarded in the same form in which they arrived at the process. For example, an IP packet arriving on a physical cable is transferred to a downstream process as an IP packet on a physical cable. However, other physical media will use different protocols and physical implementations and the present invention is readily adapted to those cases.

This approach is fundamentally inefficient because packets are continually being translated between wire formats and processable data structures. Each device must read packets off of the physical cable and translate the packet into something it can understand before processing. After processing, the packet is then placed back into wire format and then forwarded on to the next device, only to have the same process repeated. Furthermore, since no meta-data is shared between the devices, they only are capable of basic interaction. For example, the intrusion detection system has no knowledge of the routing table and is not able to make decisions based on which link originated that packet.

Since most networks have the same set of devices present (e.g., router, firewall, bandwidth manager, intrusion protection system), building a single device that provides all of this functionality would be one way to alleviate the problem described above. By integrating all of the necessary functionality into a single device, we remove the wasteful translations of packets between wire format and data structure along with the physical delays associated with moving a packet from one device to the next. This will clearly reduce the packet latency of the overall system. However, improving upon (or even maintaining) the throughput of a software stack with a single appliance is much more difficult. Each of the devices in the stack uses independent computation resources. All will have a primary processor, memory, storage and in many cases a custom ASIC coprocessor for accelerating tasks specific to the purpose of the device.

One way to implement a system that addresses all of the computational tasks of the entire system would be to custom engineer a high performance backplane to interconnect all of the hardware found in the stack of devices. In addition, a single common data structure format for the processor packets must be agreed upon by all packet processing engines. This allows a wire format packet to be translated into a processable data structure exactly once. The combination of a common packet data structure format with a high speed backplane eliminates the need for wasteful repetition of packet translation. However, there are numerous limitations with this approach. First, if new functionality is desired, the hardware of the combined device must be changed. Second, the engineering cost of such an implementation would effectively be the sum of the engineering cost of the individual devices. In addition, the backplane that interconnects the components would require significant custom engineering, further increasing the cost.

An alternative implementation uses existing general-purpose computing technology to provide a fixed amount of computational resources on which all of the features are implemented in software. One way to accomplish this involves implementing each of the features as a separate process on an operating system that executes on the hardware platform. The challenge with this approach is performance. Contemporary general purpose computers have very high performance processors but a relatively low bandwidth interconnect to memory. Since each feature is spawned by the operating system as its own process, it enjoys an operating system (OS) enforced virtual machine and memory separation. Thus packets are copied to and from a memory space addressable by each process. Load and store operations used to manipulate data in memory often consume tens or even hundreds of processor clock cycles. As the number of features increases, the number of cycles consumed by load and store operations will quickly overtake the number of cycles used in actual packet processing computations.

In order to overcome this problem the present invention copies packets from the operating system kernel into a shared memory block. Each packet processing feature is implemented as a subroutine that processes packets in place (i.e., without moving the packets between independent memory spaces or within the shared memory space). To accomplish this, all packets are stored in a common format and all provisioning modules are linked against a common data structure interpretation library. This approach has the further benefit which allows provisioning modules to primarily consist of the logic that implements the provisioning functionality. The result is a “pluggable” unified memory architecture that allows for rapid integration of additional provisioning functionality because all packet interpretation and translation needs are handled by a shared library with a well defined API.

Data hazards associated with multiple processes having access to shared memory space are avoided by using a scheduler to referee or arbitrate access to the shared memory block. Data hazards refer to situations in which two or more processes attempt to access the shared memory at overlapping times. On a uni-processor platform, simple round-robin scheduling of the packet processing subroutines enforces mutually exclusive access to the shared memory block.

Effective use of a multi-processor platform requires a more complex scheduling architecture. First, the shared memory block where packets are stored is divided into fixed size segments (e.g., 8K segments). A segment contains one or more packets in the shared data structure format. Each segment is independently addressable such that a segment can be locked for use by one processor while other segments of the shared memory remain available for use by other processors. This permits the parallel processing of packets of the unified memory architecture (assuming that the packets are in different segments). Although the segment could theoretically be variable, we have chosen to use a fixed sized segment for performance reasons. This invariable means that some space at the end of each segment will be wasted because it is impossible to predict the size of packets a priori. However, this is considered a reasonable trade off for the advantage of being able to leverage SMP hardware.

In addition, the scheduler stores a table in memory for per-segment tracking meta-data that includes, but is not limited to, a locking bit for mutually exclusive access, a processor word that identifies which processor (if any) is currently processing the segment and a status word for keeping track of what processing stages have been completed. The scheduler enforces access policies onto all packets within the segment uniformly based on the tracking meta-data. Instances of packet processing subroutines are spawned on demand as separate threads by the scheduler to allow for parallel execution. Multiprocessor systems often have operating system and/or hardware resources dedicated to maintaining consistency in shared memory structures. Accordingly, the present invention may be implemented by leveraging unified memory multiprocessor hardware (e.g., UltraSPARC, IA32, IA32e, IA64, x86-64, etc.) and operating system platforms such as (UNIX, Solaris, Linux, Windows NT and the like).

What is claimed is:

1. A packet processing method comprising:
receiving a data packet;
storing the data packet in a data structure in shared memory; and
enabling a plurality of processes to access the data structure in shared memory.

2. The packet processing method of claim 1 further comprising a scheduling process operable to arbitrate access to the shared memory amongst the plurality of processes.

3. The packet processing method of claim 1 wherein at least one of the plurality of processes comprises a router.

4. The packet processing method of claim 1 wherein at least one of the plurality of processes comprises a firewall.

5. The packet processing method of claim 1 wherein at least one of the plurality of processes comprises a bandwidth manager.

6. The packet processing method of claim 1 wherein at least one of the plurality of processes comprises an intrusion detection process.

7. The packet processing method of claim 1 wherein at least one of the plurality of processes comprises a filter.

8. The packet processing method of claim 1 wherein at least one of the plurality of processes comprises virtual private network (VPN) process.

9. The packet processing method of claim 1 wherein at least one of the plurality of processes comprises a session prioritization process.

10. The packet processing method of claim 1 wherein at least one of the plurality of processes comprises a packet capture process.

11. The packet processing method of claim 1 wherein at least one of the plurality of processes comprises a content monitor process.

12. The packet processing method of claim 1 wherein at least one of the plurality of processes comprises a usage tracking and billing process.

13. A system for processing data packets comprising:
an interface for receiving data packets from a physical connection and storing the data packets in a data structure;
a shared memory holding the data structure;
a plurality of independent packet processors each having a routine for performing a programmed action on the packets, wherein the plurality of packet processors have access to the data structure held in shared memory.

14. A data structure comprising:
a plurality of fields for storing data and header information from a network communication packet;
an interface allowing multiple packet processing processes to have access to the data and header information; and
a scheduling mechanism operable to arbitrate access to the data structure.

15. A network processor architecture comprising:
a plurality of processing nodes, each having memory and data processing resources configured to implement a network packet processing process;
a unified memory coupled to be accessed by each of the plurality of processing nodes and configured to store a network packet; and
a memory management process configured to enable shared access to the unified memory by each of the plurality of processing nodes.
